(19) United States
(12) Patent Application Publication
(10) Pub. No.: US 2012/0164496 A1
(43) Pub. Date: Jun. 28, 2012

(54) BATTERY RECEIVING DEVICE

(75) Inventors: Walter Lachenmeier, Sankt Augustin (DE); Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/147,657

(22) PCT Filed: Feb. 2, 2010
(86) PCT No.: PCT/EP10/00624

§ 371 Date: Mar. 16, 2012

(30) Foreign Application Priority Data
Feb. 4, 2009 (DE) 10 2009 007 422.8

(51) Int. Cl. H01M 2/10; H01M 10/42; B23P 19/04; H01M 10/50

(52) U.S. Cl. 429/61; 29/426.1

(57) ABSTRACT

The invention relates to a battery receiving device comprising a battery receiving chamber and a wall at least partially enclosing the battery receiving chamber. The battery receiving device further comprises a closable first opening associated with the wall. The battery receiving device further comprises a battery holding device provided for holding at least one battery. The battery receiving device according to the invention is characterized in that the battery holding device thereof is configured such that the at least one battery is released under predetermined conditions.

Priority application DE 10 2009 007 422.8 is fully incorporated by reference into the present application.

The present invention relates to a battery receiving device for at least one battery. The invention is described in connection with rechargeable lithium-ion-batteries and motor vehicles. It is pointed out that the invention can also be applied independently of the construction of the battery, the chemistry of the battery or the type of consumer.

Batteries with rigidly shaped dimensionally stable housings in motor vehicles are known from the prior art. Thin-walled housings are also known, which fit snugly against the electro-chemical components of the battery or are supported by these components. In the event of a violent shock, perhaps in an accident involving the vehicle, the battery housing can break and the battery chemicals can escape into the environment. Also, a battery housing can break if a foreign body penetrates into the space occupied by the battery.

The problem addressed by the present invention therefore is to reduce the tendency of a battery housing to break in the event of a violent shock or penetration by a foreign body. This problem is solved according to the invention by the subject matter of the independent claims. Preferred extensions of the invention form the subject matter of the dependent claims.

A battery receiving device according to the invention comprises a battery receiving chamber and a wall, at least partially enclosing the battery receiving chamber. The battery receiving device further comprises a lockable first opening that is assigned to the wall. The battery receiving device further comprises a battery holding device which is provided for holding at least one battery. The battery receiving device according to the invention is characterized by the fact that the battery holding device is configured such that the at least one battery is released under predetermined conditions.

In the context of the invention a battery receiving device is understood to mean a device which receives at least one battery for at least some of the time. The battery receiving device preferably receives multiple batteries, as long as multiple batteries are required for powering a load, in particular being electrically interconnected for supplying a motor vehicle drive unit. Preferably a main battery and a reserve battery are received by the battery receiving device at the same time.

In the context of the invention a battery receiving chamber is understood to mean a chamber in which the batteries to be received by the battery receiving device are arranged. The size and shape of the battery receiving chamber are also determined by the batteries to be received. The battery receiving chamber is preferably only slightly greater than the volume of the batteries to be received. If the battery receiving device receives multiple batteries, the battery receiving chamber also obtains its shape depending on the spatial arrangement of the batteries to be received relative to one another. The battery receiving chamber is preferably elongated and has an essentially prismatic or cylindrical footprint. The battery receiving chamber is preferably flat in comparison to its horizontal dimensions and has an essentially prismatic or cylindrical footprint.

In the context of the invention the wall of the battery receiving device is understood to mean in particular a thin-walled covering, which encloses and bounds the battery receiving chamber. Preferably, the wall only partially encloses the battery receiving chamber. Preferably, the wall is at least partially perforated, or provided with windows. This facilitates the flow of a cooling agent through the battery receiving chamber. Preferably, the wall has at least one connection region. This is also provided for connection to the motor vehicle.

In the context of the invention a lockable first opening is understood to mean a device which facilitates both the insertion of batteries into the battery receiving chamber and/or the removal of batteries as required. Preferably, the lockable first opening is part of the wall. Preferably the opening is closed off by means of a cover, a lock or a cover with a locking mechanism, so that for example a battery cannot leave the battery receiving chamber unintentionally. The opening is thus at least as large as the cross-sectional area of the largest body which is to be passed into the battery receiving chamber. The lockable first opening is preferably mounted in a region of the battery receiving chamber which is easily accessible from the outside and facilitates a simple insertion or removal of bodies, in particular a battery.

In the context of the invention a battery holding device is understood to mean a device which holds at least one battery at least temporarily. A battery holding device preferably holds multiple batteries at the same time and/or protects these batteries against unintentional displacement. Preferably, the battery holding device has guiding means for guiding a movement of a battery. Preferably the battery holding device augments the wall, to provide a complete enclosure of the battery receiving chamber.

In the context of the invention, the holding of a battery is understood to mean that the battery is at least temporarily secured against unintentional displacement. This can be achieved by locking or clamping means, which preferably rigidly hold the batteries at the respective position provided with a force fit or positive fit. These holding means of the battery holding device act in such a manner that they release a battery under predetermined conditions. Releasing a battery terminates the force fit or positive fit connection to the battery holding device. The predetermined conditions mean the existence of circumstances which can lead to damage occurring to a battery housing. These predetermined conditions also include a minimal acceleration or force or the penetration of a foreign body into the chamber occupied by a battery.

The locking or clamping means also include, in the context of the invention, latches, serrations, spline teeth, cams, bolts, pins or clamping strips. These are preferably assigned to the battery holding device. Also, geometrically undefined shapes can be used to apply a frictional force or breakaway force, such as for example a particular surface roughness. Preferably, the at least one battery with the locking or clamping means comprises mechanically interacting devices. Preferably the at least one battery is materially bonded to the battery holding device, for example by means of an adhesive joint.

By releasing the at least one battery, the acceleration of the battery caused by a shock, and/or the duration of the action of the acceleration on the battery, is reduced. The mechanical loading of the battery housing is also reduced. After its release the battery can circumvent a penetrating body. The tendency of a battery housing to break is thus reduced and the problem being addressed is solved.

Below, preferred extensions of the invention will be described.

Advantageously the battery holding device is arranged at least partially in the battery receiving chamber. Preferably, the battery holding device is at least partially enclosed by the wall.

Advantageously, the battery receiving device has an escape area assigned to it. Preferably the battery holding device extends at least partially into the escape area. After the release of a battery by the battery holding device the battery can be at least partially displaced into the escape area. The displacement takes place for example as a consequence of an acceleration or a path imparted by a foreign body. The imparted path can be a result of a deformation of the chassis of the motor vehicle, caused by an accident. The escape area preferably spatially adjoins the battery receiving chamber. Preferably, the escape area is arranged inside the battery receiving chamber. This means that the escape area is preferably arranged in the direction of the expected acceleration or of the imparted path. The escape area preferably also receives multiple batteries.

Advantageously, the wall has an outlet. The outlet is dimensioned such that a battery can be displaced through the outlet. It is sufficient that the outlet exists at the time of the displacement of a battery. For example, the outlet is only created when the at least one battery is displaced. For example, the wall is provided with a closed linear thin portion, a perforation or multiple slots. At a predetermined force this thin portion, perforation or slot yields. A part of the wall detaches from the rest of the wall and so forms an outlet. The outlet can also be permanently formed in the wall.

Preferably one bounding surface of, for example, a cuboid wall is absent.

Advantageously, the battery receiving chamber accommodates a deformation body. This can be arranged spatially near to at least one battery or in contact with this battery. The deformation body also serves to absorb energy by elastic or plastic deformation. The energy which acts thereon can act on the deformation body as strain energy. Thus the deformation body can absorb at least a part of the energy released during an accident and protect the at least one battery therefrom. The deformation body is preferably interchangeable. The arrangement of the deformation body in relation to the at least one battery is dependent on the expected acceleration or deformation.

Advantageously the battery receiving device receives multiple batteries at the same time. These batteries can be electrically interconnected, for example as a series circuit and/or in parallel. The multiple batteries are preferably tightly packed and at least partially arranged inside the battery receiving chamber. The actual arrangement used is based on the spatial parameters of the battery receiving device.

The main extension direction of the battery receiving chamber can extend along the largest dimension of the battery receiving chamber, for example in the direction of the longest edge of the battery receiving chamber. The main extension direction can extend along an axis of symmetry or longitudinal axis of the battery receiving chamber. For example, multiple batteries are arranged tightly one behind the along the main extension direction of the battery receiving device, which forms a row. Preferably the row of batteries begins or ends with a deformation body.

Advantageously the battery holding device is also arranged for exchanging thermal energy with the received batteries. Preferably, the battery holding device comprises devices for increasing the heat exchange surface area. The battery receiving device preferably comprises at least one coolant channel, which is preferably permeated by a coolant. Preferably, at least one heat sink of the battery holding device is arranged in regions where the flow rate of the coolant is high.

Advantageously a motor vehicle is equipped with a battery receiving device. Preferably, the battery receiving device is connected to the underbody or the frame of the motor vehicle. The connection is preferably formed as a material bond, for example by gluing or welding. The connection can also be made using connection elements such as screws or rivets, for example. The battery receiving device is preferably connected to a sufficiently dimensionally stable component of the vehicle. The battery receiving device can also be constructed integrally with the underbody or frame of the motor vehicle. The actual arrangement of the battery receiving device inside the motor vehicle is based on the spatial parameters and is independent of the dimensions of both the motor vehicle and the battery receiving device. Preferably the battery receiving device is arranged inside the motor vehicle such that the driving stability of the motor vehicle is taken into account. Thus the battery receiving device is preferably arranged as deeply as possible with respect to the motor vehicle. For example, the battery receiving device is arranged between the passengers in the area of the Cardan shaft tunnel of a typical modern motor vehicle, or below the passengers.

Advantageously the underbody or frame of the motor vehicle and/or the battery receiving device are produced with a reinforced polymer. The polymer is preferably fibre-reinforced, with textile fibres particularly preferably being used for reinforcing the polymer. Preferably, the battery receiving device is constructed integrally with the underbody or frame of the motor vehicle.

Advantageously the battery receiving device is arranged inside the motor vehicle such that the centre of mass of the battery receiving device and the centre of mass of the motor vehicle are spaced only a short distance apart from each other. This applies in particular to a horizontal lateral distance in relation to the direction of travel of the motor vehicle. Preferably, the horizontal lateral distance of the centre of mass of the battery receiving device from the centre of mass of the motor vehicle has a value less than one tenth of the length of the motor vehicle, particularly preferably less than 1/100th of the length of the motor vehicle.

Advantageously the escape area is arranged in a region of the motor vehicle which is only slightly deformed in the event of an accident. As long as the battery receiving device has a low profile in comparison to its horizontal extensions, the escape area can for example also be arranged underneath the rear passengers or between the rear wheels. The actual arrangement of the escape area is dependent on the type of construction of the motor vehicle and the deformation characteristics of the chassis, or of the underbody or frame of the motor vehicle.

Advantageously, the air-conditioning system of the motor vehicle is used for the temperature control of the batteries. For this purpose, the air-conditioning system is effectively connected to the battery holding device. Preferably the battery holding device comprises a thermal contact plate, which contacts the batteries at least partially, preferably over a large area, in a heat-conducting manner. This thermal contact plate comprises for example heat sinks, onto which coolants are flowing. For example, the thermal contact plate has at least one connecting pipe, which is permeated at least partially by the coolant of the air-conditioning system. Preferably, the connection between the air-conditioning system and the thermal contact plate of the battery holding device is made via flexible connecting pipes, for example hoses. Depending on the temperature difference between the batteries and the coolant of the air-conditioning system, heat energy can be fed to or away from these batteries.

Advantageously the battery receiving device is operated such that the at least one battery is first of all held in a fixed position by the battery holding device. Even in the event of a minimal force being applied to the at least one battery, the battery holding device releases this battery. The battery is now no longer held in a fixed position and can follow the force acting on it. Preferably, the motion of the at least one battery is guided. The motion of the battery is preferably decelerated, for example as a result of friction. The battery thus follows a predetermined path. After the release the battery comes to rest again relative to the battery receiving chamber. At this point in time the battery may have been displaced inside the battery holding device, or may have partially or completely exited from the battery holding device. Also, the battery may have been at least partially displaced into the escape chamber.

Advantageously, the battery receiving device, or the batteries received thereby, is/are also protected by the frame or underbody of the motor vehicle. In the event of an accident a part of the acting energy is first absorbed by the frame or underbody of the motor vehicle. Only a remainder can act so as to cause damage to the battery receiving device or the batteries received thereby.

Further advantages, features and application possibilities of the invention in the context of the inventions can be obtained from the following description in connection with the figures. They show:

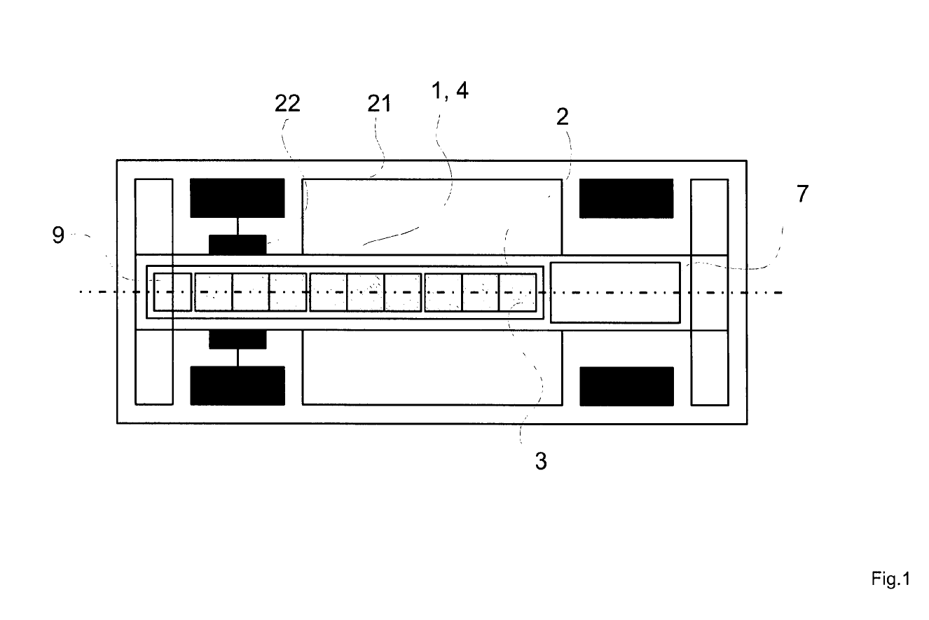

FIG. 1 a schematic plan view of a motor vehicle with its frame and with a battery receiving device according to the invention,

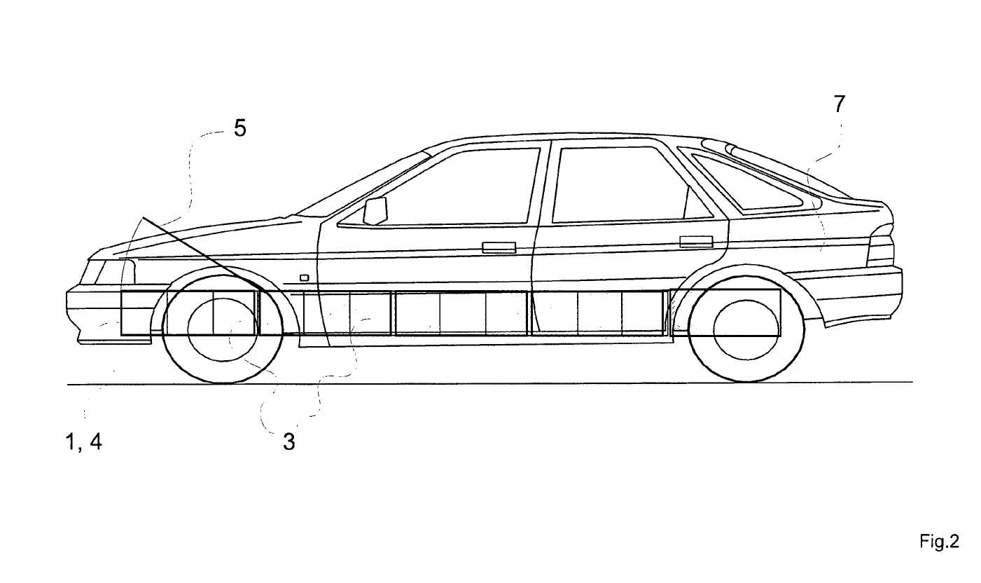

FIG. 2 a side view of a motor vehicle with a battery receiving device,

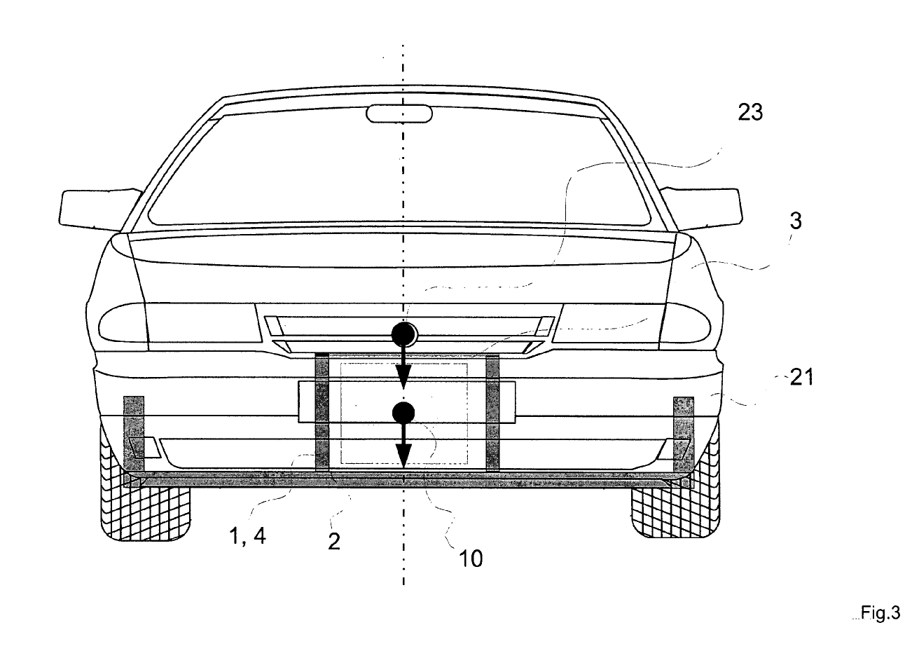

FIG. 3 a front view of a motor vehicle with a battery receiving device and with the underbody of the motor vehicle,

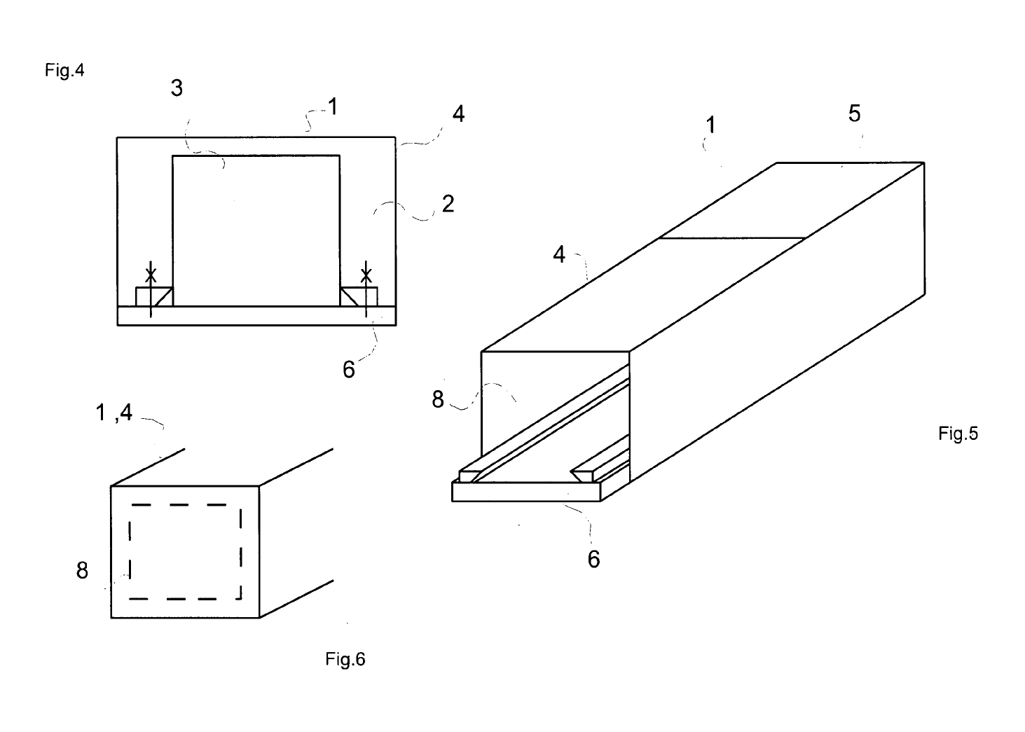

FIG. 4 a sectional view of a battery receiving device according to the invention,

FIG. 5 a perspective view of a battery receiving device according to the invention,

FIG. 6 a perspective view of a part of a battery receiving device according to the invention in a preferred embodiment,

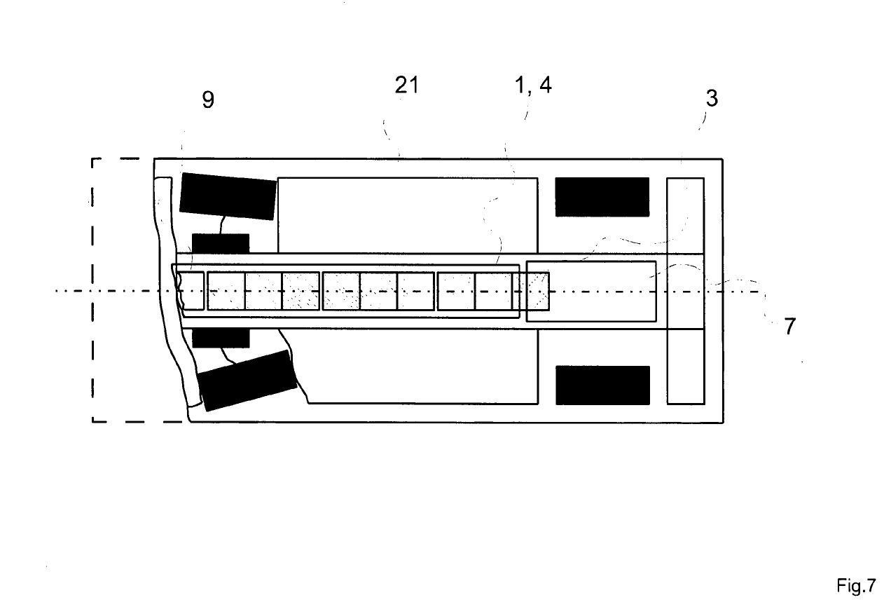

FIG. 7 a schematic plan view of a motor vehicle with a battery receiving device according to the invention following an accident.

FIG. 1 shows a schematic view from above, also of the frame 21 of a motor vehicle, which is equipped with a battery receiving device 1 according to the invention. The motor vehicle comprises an electrical drive unit with two electric motors 22. The battery receiving device 1 is arranged inside the frame 21 or the underbody of the motor vehicle. Inside the battery receiving chamber 2, a number of batteries 3 and a deformation body 9 are arranged. The main extension direction of the battery receiving device 1 is aligned essentially parallel to the direction of travel or the longitudinal axis of the motor vehicle. The battery receiving device 1 is assigned an escape area 7. This is arranged in the direction of travel behind the battery receiving device 1. The battery receiving device 1 is arranged inside the frame 21 such that the horizontal distance of the centre of mass of the battery receiving device from the centre of mass of the motor vehicle is as small as possible. Further, the battery receiving device 1 is arranged as deep as possible inside the motor vehicle.

This aids the driving stability of the motor vehicle.

FIG. 2 shows a side view of the motor vehicle with a battery receiving device 1 according to the invention. The wall 4 comprises a lockable first opening 5 in the area of the front part of the chassis. After opening the lockable opening 5, a battery 3 can also be inserted or removed. An escape area 7 is arranged in the direction of travel behind the battery receiving device 1. The battery receiving device 1 is arranged as deep as possible inside the underbody.

FIG. 3 shows a motor vehicle with a battery receiving device 1 according to the invention, which is connected to the underbody 21 of the motor vehicle. Both the wall 4 of the battery receiving device 1 and the underbody 21 of the motor vehicle comprise a textile reinforced polymer. Inside the battery receiving chamber 2 at least one battery 3 is arranged. The battery holding device is not shown. A vertical reference line is drawn in the figure, which passes through both the centre of mass 10 of the battery receiving device 1 and the centre of mass 23 of the motor vehicle.

FIG. 4 shows a cross-section through a battery receiving device 1 according to the invention. Inside the battery receiving chamber 2 at least one battery 3 and a battery holding device 6 are arranged. This battery holding device 6 has clamping strips, which serve both to hold a battery and to guide a movement of the battery 3. The clamping strips are screwed to the battery holding device 6. The at least one battery 3 is also forced down onto the baseplate of the battery holding device 6 with a normal force. Only when the frictional force is exceeded, for example as a result of a corresponding acceleration, can the battery 3 be displaced.

FIG. 5 shows that the battery holding device 6 extends partially out of the battery receiving chamber 2. This is enclosed to a large extent by the wall 4. The wall 4 comprises a lockable first opening 5. Not shown is the escape area 7 into which the battery holding device 6 partially extends. Under corresponding displacement a battery 3 passes through the outlet 8 and at least partially enters into the escape area.

FIG. 6 shows a further design of the outlet 8 of a battery receiving device 1 according to the invention. The outlet arises only on the displacement of a battery. For this purpose the wall 4 comprises a pre-determined breaking point in the form of a circumferential line or a circumferential band. This pre-determined breaking point fails under predetermined conditions, in particular when sufficient force acts on the pre-determined breaking point and opens up the outlet 8.

FIG. 7 shows a motor vehicle with a battery receiving device 1 according to the invention following an accident. The front part of the chassis of the motor vehicle is deformed as a result of the accident. The frame 21 is also deformed. It is illustrated that in addition, both the wall 4 of the battery receiving device 1 and the deformation body 9 are deformed by the accident. One of the batteries 3 is partially displaced into the escape area 7. The remaining batteries are also displaced as a result of the accident. With the displacement the damaging effect of forces and energies from the accident on the batteries 3 is reduced. The housings of the batteries 3 are undamaged, escape of the chemicals from the batteries 3 is prevented and the problem addressed is solved.

1.-14. (canceled)

15. A battery receiving device (1) comprising:
a battery receiving chamber (2),
a wall (4), at least partially enclosing the battery receiving chamber (2),
a lockable first opening (5), assigned to the wall (4),
and a battery holding device (6), which is provided for holding at least one battery (3) and is configured such that the at least one battery (3) is released under predetermined conditions,
wherein
the battery receiving chamber (2) is provided for also receiving a deformation body (9).

16. The battery receiving device (1) according to claim 15,
wherein
the battery holding device (6) is provided for exchanging thermal energy with the at least one battery (3).

17. The battery receiving device (1) according to claim 16,
wherein
the battery holding device (6) is arranged partially, in particular completely in the battery receiving chamber (2).

18. The battery receiving device (1) according to claim 17,
wherein
said battery receiving device (1) is assigned an escape chamber (7), which is provided to at least partially receive at least one battery (3).

19. The battery receiving device (1) according to claim 18
wherein
the wall (4) additionally contains an outlet (8), which is provided to allow the at least one battery to at least partially exit from the battery receiving chamber under predetermined conditions.

20. The battery receiving device (1) according to claim 19,
wherein
the battery receiving device (1) extends essentially along a main extension direction, and that the battery receiving device (1) receives multiple batteries (3) at the same time, which are arranged in particular along the main extension direction of the battery receiving device (1).

21. Motor vehicle with a battery receiving device (1) according to claim 20,
wherein
the battery receiving device (1) is assigned to the underbody of the motor vehicle.

22. Motor vehicle with a battery receiving device (1) according to claim 21,
wherein
the wall (4) of the battery receiving device (1) or the underbody of the motor vehicle comprises a reinforced polymer.

23. Motor vehicle with a battery receiving device (1) according to claim 22,
wherein
the centre of mass (10) of the battery receiving device (1) is spaced a predetermined distance from the centre of mass (22) of the motor vehicle.

24. Motor vehicle with a battery receiving device (1) according to claim 23,
wherein
the main extension direction of the battery receiving device (1) is arranged essentially parallel to the direction of travel of the motor vehicle.

25. Motor vehicle with a battery receiving device (1) according to claim 24,
wherein
the escape area (7) is arranged in a protected area.

26. Motor vehicle with a battery receiving device (1) according to claim 25,
wherein
the motor vehicle comprises an air-conditioning system, which is effectively connected to the battery holding device (6) for exchanging thermal energy.

27. Method for operating a battery receiving device (1) according to claim 26,
wherein
the battery holding device (6) releases at least one battery under predetermined conditions,
the at least one battery (3) subsequently moves according to the force acting thereon, in particular in the direction of the escape chamber,
and that the relative velocity between the at least one battery (3) and the battery receiving chamber (2) reduces again after a predetermined path.
